(19) United States
(12) Patent Application Publication
(10) Pub. No.: US 2013/0076869 A1
(43) Pub. Date: Mar. 28, 2013

(54) IMAGING APPARATUS AND METHOD FOR CONTROLLING SAME

(71) Applicant: Masayuki Mukunashi, Yokohama-shi (JP)

(72) Inventor: Masayuki Mukunashi, Yokohama-shi (JP)

(73) Assignee: CANON KABUSHIKI KAISHA, Tokyo (JP)

(21) Appl. No.: 13/613,254

(22) Filed: Sep. 13, 2012

(30) Foreign Application Priority Data
Sep. 22, 2011 (JP) 2011-207431

(51) Int. Cl. H04N 13/02

(52) U.S. Cl. 348/49; 348/E13.074

(57) ABSTRACT

Provided is an imaging apparatus that includes an imaging element in which pixel portions each having a plurality of photoelectric conversion units, which generate image signals by photoelectrical conversion, with respect to one micro lens are arranged side by side in a horizontal direction and a vertical direction, an imaging element controller having a first mode which outputs a first left-eye image signal and/or right-eye image signal from the imaging element by composing signals from the plurality of photoelectric conversion units and a second mode which outputs signals without performing the composing and a controller that outputs a second left-eye image signal and/or right-eye image signal by composing signals output in the second mode based on image data stored in a storage unit in response to the type of photographing of which the start has been detected.

### BACKGROUND OF THE INVENTION

1. Field of the Invention

The present invention relates to an imaging apparatus and a method for controlling the same.

2. Description of the Related Art

Stereo cameras for performing three-dimensional image photographing have been proposed. For example, Japanese Patent Laid-Open No. 01-202985 discloses a stereo camera that acquires a stereo image including a left-eye image and a right-eye image using two optical units and two imaging elements. Also, Japanese Patent Laid-Open No. 58-24105 discloses a solid-state imaging element in which a plurality of micro lenses is formed and at least one pair of photodiodes serving as photoelectric conversion units is arranged close to each of the micro lenses. Of the pair of photodiodes, a first image signal is obtained from the output of one photodiode and a second image signal is obtained from the output of the other photodiode. The stereo camera allows a user to view a stereoscopic image using the first and second image signals as a left-eye image and a right-eye image, respectively.

On the other hand, there has been proposed a digital camera by which a user can confirm the composition of an image while the digital camera displays the image captured from an imaging element in real-time (live-view display) via an image display unit and photographs a still picture image using the composition. Live-view can realize a smooth motion picture by displaying many more images in a unit time. In other words, when the type of photographing which is started by an imaging apparatus is a live-view photographing for performing photographing in a state where an image of an object is capable of being viewed via an image display unit, a smooth motion picture cannot be realized if too much time is taken to capture an image signal from the imaging element. Thus, it is important to ensure that the amount of data for capturing an image from the imaging element is reduced as much as possible so as to shorten the time taken to capture the image.

However, if the number of photodiodes provided in each of pixel portions included in the imaging element increases, the amount of data to be read from the imaging element increases, and thus, a smooth motion picture cannot be displayed. In contrast, if the imaging apparatus performs still picture photographing, it is advantageous that data from as many photodiodes as possible be recorded in order to increase the degree of freedom for image processing in later steps.

### SUMMARY OF THE INVENTION

Accordingly, the present invention provides an imaging apparatus that photographs a left-eye image and a right-eye image and reduces the time taken to capture an image signal from an imaging element during live-view photographing and stores the image signal in order to increase the degree of freedom for image processing in later steps.

According to an aspect of the present invention, an imaging apparatus is provided that includes an imaging element in which pixel portions each having a plurality of four or more photoelectric conversion units, which generate image signals by photoelectrical conversion, with respect to one micro lens are arranged side by side in a horizontal direction and a vertical direction; an imaging element controller having a first mode which outputs a first left-eye image signal and/or right-eye image signal from the imaging element by composing signals from the plurality of photoelectric conversion units and a second mode which outputs signals without the composing; and a controller that outputs a second left-eye image signal and/or right-eye image signal by composing signals output in the second mode based on image data stored in a storage unit in response to the type of photographing for which the start has been detected.

Further features of the present invention will become apparent from the following description of exemplary embodiments with reference to the attached drawings.

### BRIEF DESCRIPTION OF THE DRAWINGS

FIG. 1 is a diagram illustrating an exemplary configuration of the imaging apparatus of the present embodiment.

FIG. 2A is a diagram illustrating the general configuration of an imaging element.

FIG. 2B is a diagram illustrating an exemplary configuration of a pixel portion of an imaging element.

FIG. 3 is a diagram illustrating an exemplary pixel array.

FIG. 4 is a conceptual diagram illustrating how a light flux emitted from the exit pupil of a photographing lens enters an imaging element.

FIG. 5 is a flowchart illustrating an example of operation processing performed by the imaging apparatus of the first embodiment.

FIG. 6 is a flowchart illustrating an example of operation processing performed by the imaging apparatus of the second embodiment.

### DESCRIPTION OF THE EMBODIMENTS

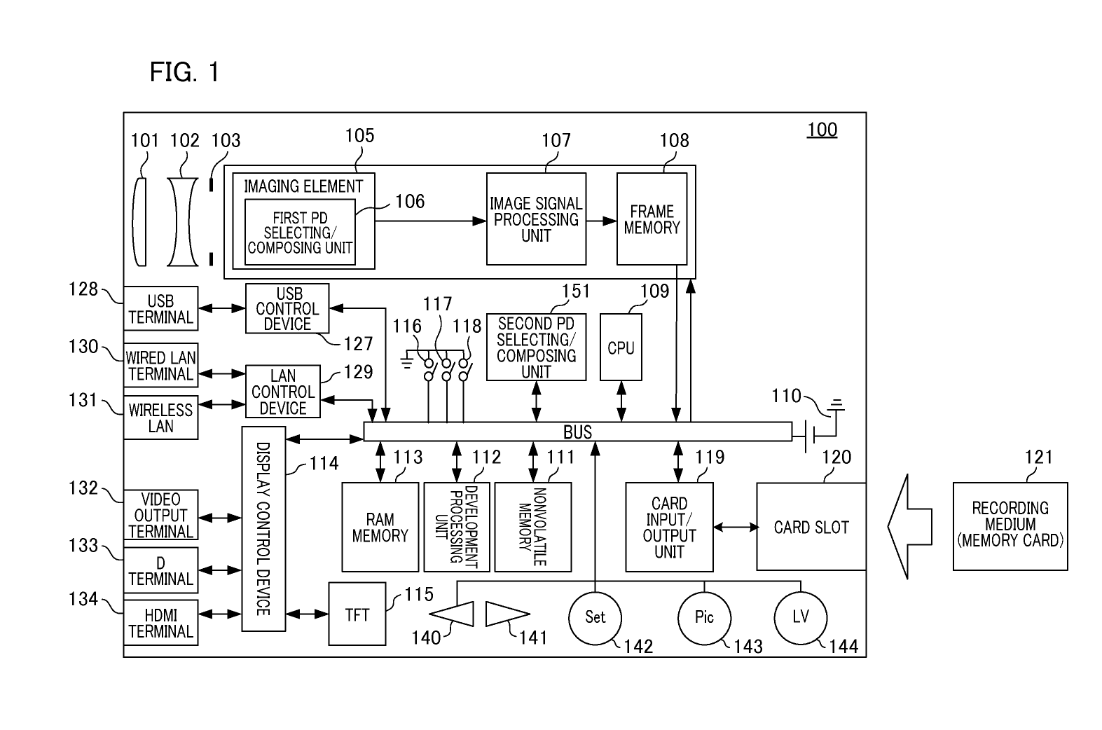

FIG. 1 is a diagram illustrating an exemplary configuration of the imaging apparatus of the present embodiment. The imaging apparatus of the present embodiment is, for example, a digital camera. Among the components provided in the imaging apparatus shown in FIG. 1, a digital camera body 100 photographs an object. A CPU 109 controls the imaging apparatus overall. A power source 110 supplies power to the circuits provided in the digital camera body 100. A card slot 120 is a slot through which a memory card 121 serving as a removable storage medium can be inserted. The memory card 121 is electrically connected to a card input/output unit 119 with the memory card 121 inserted into the card slot 120. Although, in the present embodiment, the memory card 121 is employed as a storage medium, another storage medium such as a hard disk, an optical disk, a magneto-optical disk, a magnetic disk or another solid memory may also be employed.

A focusing lens 101 performs focus adjustment by being advanced or retracted in a direction along the optical axis. An aperture 103 adjusts an amount of light to be applied to an imaging element. The focusing lens 101 and the aperture 103 constitute an imaging optical system. An imaging element 105, an image signal processing unit 107, and a frame memory 108 constitute a photoelectric conversion system. The photoelectric conversion system converts an optical image of an object formed by the imaging optical system into a digital image signal or image data.

The imaging element 105 functions as a photoelectric conversion unit that photoelectrically converts an image of an object formed by the imaging optical system and outputs an image signal. The imaging element 105 is a CCD (Charge Coupled Device) imaging element, a CMOS (Complementary Metal Oxide Semiconductor) imaging element, or the like. The imaging element 105 includes a first PD selecting/composing unit 106. The first PD selecting/composing unit 106 has functions for selecting a photodiode (hereinafter referred to as “PD”) and for composing and outputting the selected image signal. Note that the first PD selecting/composing unit 106 may also be provided external to the imaging element 105.

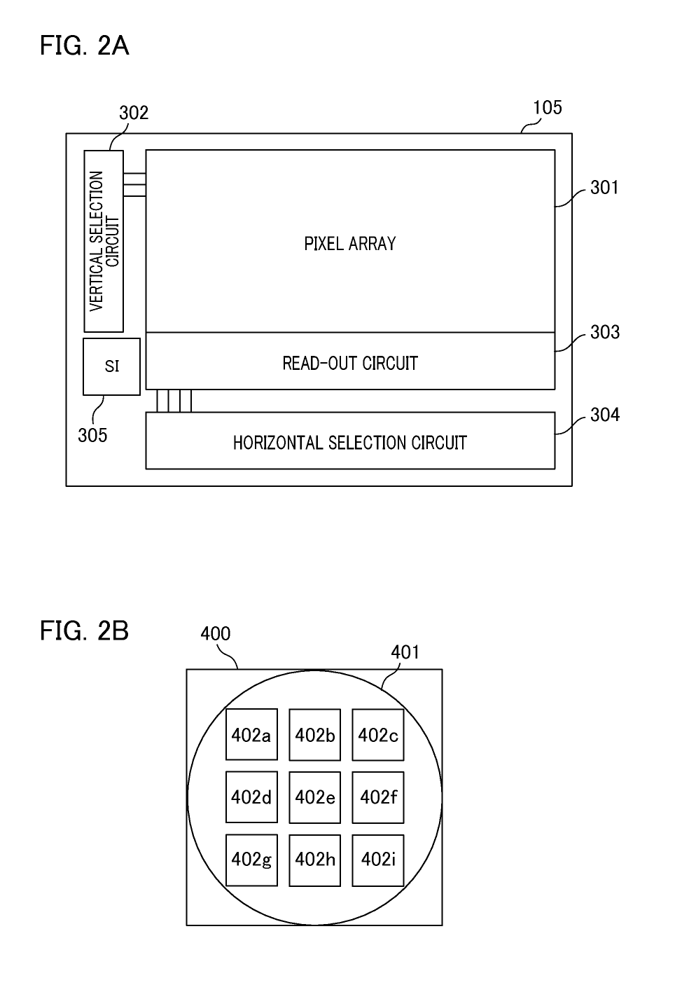

FIGS. 2A and 2B are diagrams schematically illustrating an exemplary configuration of an imaging element that is applied to the imaging apparatus of the present embodiment. FIG. 2A is a diagram illustrating the general configuration of an imaging element. An imaging element 105 includes a pixel array 301, a vertical selection circuit 302 that selects a row in the pixel array 301, and a horizontal selection circuit 304 that selects a column in the pixel array 301. A read-out circuit 303 reads a signal of a pixel portion which has been selected from among the pixel portions in the pixel array 301 by the vertical selection circuit 302. The read-out circuit 303 has a memory for accumulating signals, a gain amplifier, an A (Analog)/D (Digital) converter, or the like for each column.

A serial interface (SI) unit 305 determines the operation mode of each circuit in accordance with the instructions given by the CPU 109. The vertical selection circuit 302 sequentially selects a plurality of rows of the pixel array 301 so that a pixel signal(s) is extracted to the read-out circuit 303. Also, the horizontal selection circuit 304 sequentially selects a plurality of pixel signals read by the read-out circuit 303 for each row. Note that the imaging element 105 includes a timing generator that provides a timing signal to the vertical selection circuit 302, the horizontal selection circuit 304, the read-out circuit 303, and the like, a control circuit, and the like in addition to the components shown in FIG. 2, but no detailed description thereof will be given.

FIG. 2B is a diagram illustrating an exemplary configuration of a pixel portion of the imaging element 105. A pixel portion 400 shown in FIG. 2B has a micro lens 401 serving as an optical element and a plurality of photodiodes (hereinafter abbreviated as “PD”) 402a to 402i serving as light receiving elements. The PD functions as a photoelectric conversion unit that receives a light flux and photoelectrically converts the light flux to thereby generate an image signal. Although FIG. 2B shows an example in which the number of PDs provided in one pixel portion is nine, the number of PDs may be any number that is two or more. Note that the pixel portion also includes a pixel amplifier for reading a PD signal to the read-out circuit 303, a selection switch for selecting a row, and a reset switch for resetting a PD signal in addition to the components shown in FIG. 2B.

The PDs 402a to 402g photoelectrically convert the received light flux to thereby output a right-eye image signal. The PDs 402c to 402i photoelectrically convert the received light flux to thereby output a left-eye image signal. The left-eye image signal is an image signal corresponding to left-eye image data. Left-eye image data is image data which is viewed by the left eye of a user. The right-eye image signal is an image signal corresponding to right-eye image data. The imaging apparatus 100 causes a user to view left-eye image data with his/her left eye and right-eye image data with his/her right eye, whereby the user views a stereoscopic image. Note that the pixel portion 400 also includes a pixel amplifier for extracting a PD signal to the read-out circuit 303, a row selection switch, and a reset switch for resetting a PD signal in addition to the components shown in FIG. 2B.

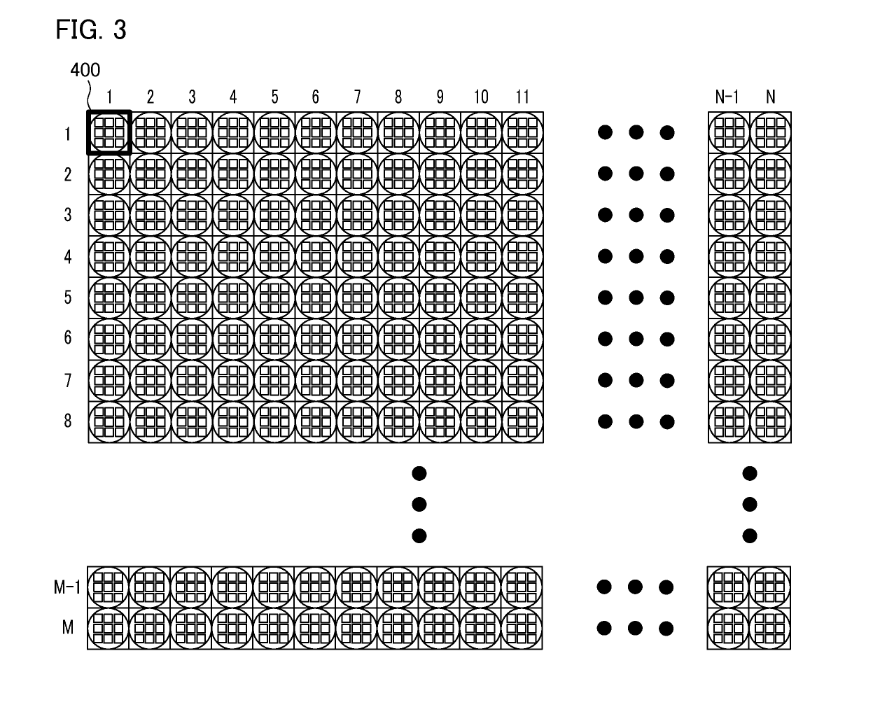

FIG. 3 is a diagram illustrating an exemplary pixel array. The pixel array 301 provides a two-dimensional image, and thus, is arranged in a two-dimensional array of “N” pixel portions in the horizontal direction and “M” pixel portions in the vertical direction as shown in FIG. 3. Each pixel portion of the pixel array 301 has a color filter. In this example, an odd row is a repetition of a red (R) and a green (G) color filters, and an even row is a repetition of a green (G) and a blue (B) color filters. In other words, the pixel portions provided in the pixel array 301 are arranged in a predetermined pixel array (in this example, Bayer array).

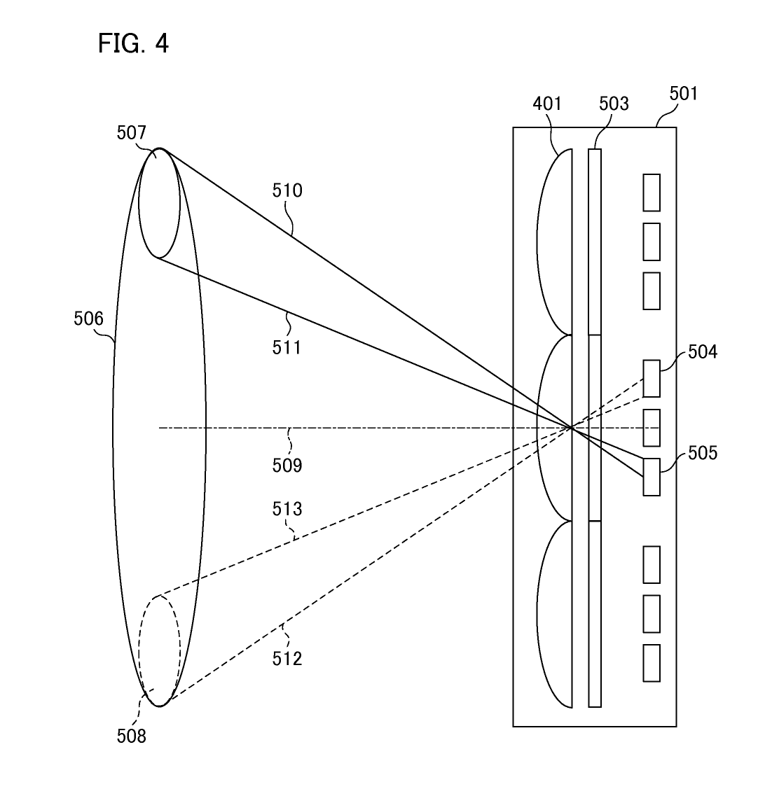

Next, a description will be given of the light reception of an imaging element having the pixel configuration shown in FIG. 3. FIG. 4 is a conceptual diagram illustrating how a light flux emitted from the exit pupil of a photographing lens enters an imaging element. Reference numeral 501 denotes the cross-section of three pixel arrays. Each pixel array has a micro lens 401, a color filter 503, and PDs 504 and 505. The PD 504 corresponds to the PD 402a shown in FIG. 2B. Also, the PD 505 corresponds to the PD 402c shown in FIG. 2B.

Reference numeral 506 denotes the exit pupil of a photographing lens. In this example, the center axis of the light flux emitted from an exit pupil 506 to a pixel portion provided in a micro lens 401 is the optical axis 509. The light emitted from the exit pupil 506 enters the imaging element 105 centered on the optical axis 509. Reference numerals 507 and 508 represent the partial regions of the exit pupil 506 of the photographing lens. The partial regions 507 and 508 are the different divided regions of the exit pupil of the imaging optical system. Light beams 510 and 511 are the outermost peripheral light beams of light passing through the partial region 507. Light beams 512 and 513 are the outermost peripheral light beams of light passing through the partial region 508. Among the light fluxes emitted from the exit pupil 506, the upper light flux enters the PD 505 and the lower light flux enters the PD 504 with the optical axis 509 serving as a boundary. In other words, each of the PDs 504 and 505 has the property of receiving light emitted from a different region of the exit pupil of the photographing lens.

The imaging apparatus can acquire at least two images having a parallax by making use of such properties. For example, the imaging apparatus sets data obtained from a plurality of left-side PDs and data obtained from a plurality of right-side PDs as a first line and a second line, respectively, in a region in a pixel portion to thereby enable acquiring two images. Then, the imaging apparatus detects a phase difference using the two images to thereby enable realizing a phase difference AF. Furthermore, the imaging apparatus makes use of the two images having a parallax as a left-eye image and a right-eye image to thereby generate a stereo image and displays the stereo image on a stereo display device, whereby the imaging apparatus can display an image having a stereoscopic effect.

From the foregoing description, the imaging element 105 is an imaging element in which pixel portions each having a plurality of photoelectric conversion units, which photoelectrically convert light fluxes that have passed through different divided regions of an exit pupil of an imaging optical system to thereby generate image signals, are arranged side by side in a horizontal direction and a vertical direction with respect to one micro lens.

Referring back to FIG. 1, the first PD selecting/composing unit 106 includes the vertical selection circuit 302, the read-out circuit 303, the horizontal selection circuit 304, and the S1305 as described with reference to FIG. 2A. The first PD selecting/composing unit 106 is operated in accordance with the operation mode of the first PD selecting/composing unit 106, which is set by the CPU 109 in response to the type of photographing for which the start has been detected in the imaging apparatus 100. Examples of the operation mode of the first PD selecting/composing unit 106 include a live-view right-eye mode, a live-view left-eye mode, a both-eyes selecting/composing mode, and a non-selecting/composing mode. In the present embodiment, the live-view right-eye mode, the live-view left-eye mode, or the both-eyes selecting/composing mode is defined as a first mode and the non-selecting/composing mode is defined as a second mode.

The live-view right-eye mode is an operation mode for generating right-eye RAW data for live-view. More specifically, the live-view right-eye mode is an operation mode for selecting a PD (first photoelectric conversion unit) that generates a right-eye image signal. Right-eye RAW data for live-view is RAW data which is the basis for generating a right-eye image for live-view display. RAW data is image data stored in the frame memory 108. In other words, the frame memory 108 functions as a storage unit that stores image data output by the first PD selecting/composing unit 106.

The live-view left-eye mode is an operation mode for generating left-eye RAW data for live-view. More specifically, the live-view left-eye mode is an operation mode for selecting a PD (second photoelectric conversion unit) that generates a left-eye image signal. Left-eye RAW data for live-view is RAW data which is the basis for generating a left-eye image for live-view display.

The both-eyes selecting/composing mode is an operation mode for generating both-eyes RAW data. More specifically, the both-eyes selecting/composing mode is an operation mode for selecting both a PD for generating a right-eye image signal and a PD for generating a left-eye image signal.

The non-selecting/composing mode is an operation mode for generating RAW data for all PDs (all PD RAW data). More specifically, the non-selecting/composing mode is an operation mode for selecting all of the plurality of PDs provided in each of the pixel portions included in the imaging element. All PD RAW data is data corresponding to image signals which are output by all of the plurality of PDs provided in each of the pixel portions included in the imaging element.

In other words, the first PD selecting/composing unit 106 functions as an imaging element controller that executes the following processing in response to the type of photographing for which the start has been detected. The first PD selecting/composing unit 106 selects any one of the PDs for generating a left-eye image signal, the PDs for generating a right-eye image signal, or all of the plurality of PDs from among the plurality of PDs included in each of the pixel portions included in the imaging element, and generates and outputs image data based on a signal generated by the selected PD(s).

The CPU 109 functions as a photographing detection unit that detects the start of photographing and the type of photographing prior to setting the operation mode of the first PD selecting/composing unit 106. If the type of photographing for which the start has been detected by the CPU 109 is the live-view photographing, the CPU 109 sets the operation mode of the first PD selecting/composing unit 106 to the live-view right-eye mode. The live-view photographing is the photographing to be performed in a state where a user can view an image of an object via a display device serving as an image display unit.

The first PD selecting/composing unit 106 generates right-eye RAW data for live-view in accordance with the set live-view right-eye mode. More specifically, the first PD selecting/composing unit 106 averages the signals of the PDs corresponding to the PDs 402a, 402d, and 402g among the PDs provided in a plurality of pixel portions which are treated as one processing unit to thereby obtain one output value for the pixel portions. The first PD selecting/composing unit 106 averages the signals of the PDs for all of the processing units, outputs the signals as right-eye RAW data for live-view, and stores them in the frame memory 108. Then, the development processing unit 112 develops right-eye RAW data for live-view in the frame memory 108 to thereby generate a right-eye image for live-view display. After processing for generating a right-eye image for live-view display is completed, the CPU 109 sets the operation mode of the first PD selecting/composing unit 106 to the live-view left-eye mode.

If the type of photographing for which the start has been detected by the CPU 109 is the live-view photographing, the CPU 109 may set the operation mode of the first PD selecting/composing unit 106 to the live-view left-eye mode to thereby cause the first PD selecting/composing unit 106 to generate left-eye RAW data for live-view. Then, after processing for generating a left-eye image for live-view display is completed, the CPU 109 may set the operation mode of the first PD selecting/composing unit 106 to the live-view right-eye mode.

The first PD selecting/composing unit 106 for which the operation mode is set to the live-view left-eye mode averages the signals of the PDs corresponding to the PDs 402c, 402f, and 402i among the PDs provided in a plurality of pixel portions which are treated as one processing unit to thereby obtain one output value for the pixel portions. The first PD selecting/composing unit 106 averages the signals of the PDs for all of the processing units, outputs the signals as left-eye RAW data for live-view, and stores them in the frame memory 108. Then, the development processing unit 112 develops left-eye RAW data for live-view in the frame memory 108 to thereby generate a left-eye image for live-view display.

From the foregoing description, the first PD selecting/composing unit 106 generates and outputs an image signal for one pixel portion based on image signals generated by three PDs during live-view photographing, whereby the amount of data can be reduced.

Hereinafter, a description will be given of an exemplary operation of the first PD selecting/composing unit 106 with reference to FIG. 3. In FIG. 3, a pixel portion on the nth row and mth column is represented by an n-m pixel portion (n≧1, m≧1). The first PD selecting/composing unit 106 calculates the first red pixel portion output in the first row as follows so as to average three pixel portions of the same color in the horizontal direction. When the operation mode is the live-view left-eye mode, the first PD selecting/composing unit 106 executes the following signal output processing by setting pixel portions 1-1, 1-3, and 1-5 as one processing unit. In other words, the first PD selecting/composing unit 106 acquires image signals generated by the PDs 402a to 402g provided in each of the pixel portions included in the imaging element and performs averaging processing for the acquired image signals to thereby obtain one output value for the pixel portions.

For the next red pixel portion output, the first PD selecting/composing unit 106 executes the same averaging processing by setting pixel portions 1-7, 1-9, and 1-11 as one processing unit. For the first green pixel portion output in the first row, the first PD selecting/composing unit 106 executes the same averaging processing by setting pixel portions 1-2, 1-4, and 1-6 as one processing unit. When the operation mode is the live-view right-eye mode, the first PD selecting/composing unit 106 performs averaging processing for image signals generated by the PDs 402c to 402i provided in the pixel portions which are treated as one processing unit.

The first PD selecting/composing unit 106 may also determine one processing unit as follows. In other words, the first PD selecting/composing unit 106 selects pixel portion groups at predetermined intervals in the vertical direction, and selects a predetermined number of pixel portions having the same color filter in the horizontal direction from among the pixel portions included in each of the selected pixel portion groups. The first PD selecting/composing unit 106 sets the selected number of pixel portions as one processing unit.

In this example, the first PD selecting/composing unit 106 selects a pixel portion group for each vertical three pixel portions. Thus, among the pixel portion groups arranged in the vertical direction provided in the pixel array shown in FIG. 3, the first PD selecting/composing unit 106 selects pixel portion groups which are spaced at two row intervals, such as a pixel portion group in the first row and a pixel portion group in the fourth row. In the pixel portion group in the first row, a red pixel portion and a green pixel portion are arranged alternately. In the pixel portion group in the fourth row, a green pixel portion and a blue pixel portion are arranged alternately.

The first PD selecting/composing unit 106 selects three pixel portions having the same color filter from the pixel portions included in each of the selected pixel portion groups at every other interval in the horizontal direction, that is, at an interval of one pixel portion in the horizontal direction. The first PD selecting/composing unit 106 sets the selected three pixel portions as one processing unit.

In the present embodiment, for the first green pixel portion output in the fourth row, the first PD selecting/composing unit 106 executes the aforementioned averaging processing by setting pixel portions 4-1, 4-3, and 4-5 as one processing unit. For the first blue pixel portion output in the fourth row, the first PD selecting/composing unit 106 executes the aforementioned averaging processing by setting pixel portions 4-2, 4-4, and 4-6 as one processing unit.

Specifically, the first PD selecting/composing unit 106 executes the following processing if the type of photographing for which the start has been detected is the live-view photographing. The first PD selecting/composing unit 106 selects the PDs for generating a left-eye image signal or the PDs for generating a right-eye image signal and selects a predetermined plurality of pixel portions from the plurality of pixel portions provided in the imaging element as one processing unit. The first PD selecting/composing unit 106 executes signal output processing for outputting an image signal corresponding to one pixel portion by averaging image signals generated by the selected PDs provided in the selected pixel portions. The first PD selecting/composing unit 106 executes the signal output processing each time the PDs for generating a left-eye image signal or the PDs for generating a right-eye image signal are selected.

For example, the first PD selecting/composing unit 106 selects the PDs for generating a left-eye image signal or the PDs for generating a right-eye image signal, and executes signal output processing for all of the processing units. After RAW data for live-view corresponding to the image signals generated by the selected PDs is generated by the signal output processing, the first PD selecting/composing unit 106 selects the unselected PDs from among the PDs for generating a left-eye image signal or the PDs for generating a right-eye image signal. Then, the first PD selecting/composing unit 106 executes signal output processing for all of the processing units to thereby generate RAW data for live-view corresponding to the image signals generated by the selected PDs. In this manner, the first PD selecting/composing unit 106 generates left-eye RAW data for live-view (left-eye moving picture data) and right-eye RAW data for live-view (right-eye moving picture data).

If the type of photographing for which the start has been detected by the CPU 109 is the live-view photographing, the CPU 109 may also set the operation mode of the first PD selecting/composing unit 106 to the both-eye selecting/composing mode.

The first PD selecting/composing unit 106 for which the operation mode is set to the both-eye selecting/composing mode executes the following processing by selecting the PDs for generating a left-eye image signal and the PDs for generating a right-eye image signal. The first PD selecting/composing unit 106 averages the image signals generated by the selected PDs provided in the pixel portions that are treated as one processing unit in each of the PDs for generating a left-eye image signal and the PDs for generating a right-eye image signal to thereby output two image signals corresponding to one pixel portion. The first PD selecting/composing unit 106 executes the signal output processing for all of the processing units to thereby generate RAW data including left-eye RAW data and right-eye RAW data both for live-view and store it in the frame memory 108.

If the type of photographing for which the start has been detected by the CPU 109 is the still performing picture photograph, the CPU 109 sets the operation mode of the first PD selecting/composing unit 106 to the non-selecting/composing mode. The first PD selecting/composing unit 106 for which the operation mode is set to the non-selecting/composing mode selects all of the plurality of PDs provided in each of the pixel portions included in the imaging element and generates still picture data based on the image signals generated by the selected PDs. More specifically, the first PD selecting/composing unit 106 averages the image signals of all of the nine PDs included in each of the pixel portions and sets the addition/averaging result as the output value of the pixel portion to thereby generate RAW data for a still picture. The first PD selecting/composing unit 106 stores the generated RAW data for still picture in the frame memory 108.

Referring back to FIG. 1, the imaging element 105 has an electronic shutter function that is capable of adjusting an exposure time. The imaging apparatus may also be constructed to adjust an exposure time using a mechanical shutter instead of the electronic shutter function. An image signal processing device 107 carries out well-known image signal processing such as shading correction or the like for a digital image signal.

The image signal processing device 107 corrects nonlinearity of image density caused by the properties of the imaging element 105 and deviation of image color caused by a light source. The frame memory 108 functions as a buffer memory that temporarily stores image data (RAW data) generated by the imaging element 105 and the image signal processing device 107. Although RAW data to be stored in the frame memory 108 has already been subjected to correction processing or the like, RAW data can be considered as digitalized data of charge energy accumulated in the pixel portions of the imaging element 105.

Here, left-eye RAW data and right-eye RAW data for live-view are collectively referred to as “RAW data for live-view”. RAW data for live-view is obtained as a result of averaging processing for the image signals which are generated by the PDs included in a plurality of pixel portions by the first PD selecting/composing unit 106. In other words, RAW data for live-view has a small amount of data, resulting in an increase in frame rate upon read-out of RAW data for live-view by the imaging apparatus during live-view display.

On the other hand, all PD RAW data corresponds to all of the image signals generated by the PDs provided in the pixel portions. All PD RAW data is stored in the frame memory 108. All PD RAW data has detailed information about image data, resulting in an increase in the degree of freedom for various types of image processing in later steps. A parameter relating to the quality of an image of RAW data is referred to as an “imaging parameter”. Examples of such an imaging parameter include “Av”, “Tv”, and “ISO” which are the set values for the aperture 103.

The CPU 109, the power source 110, a nonvolatile memory 111, the development processing unit 112, a RAM memory 113, a display control device 114, and a main switch 116 are connected to a bus 150, where CPU is an abbreviation for Central Processing Unit and RAM is an abbreviation for Random Access Memory. A first release switch 117, a second release switch 118, operation buttons 140 to 142, a development parameter change button 143, a live-view start/end button 144, a card input/output unit 119, and a second PD selecting/composing unit 151 are also connected to the bus 150. Furthermore, a USB control device 127 and a LAN (Local Area Network) control device are connected to the bus 150.

The CPU 109 controls reading-out of an image signal from the imaging element 105. In other words, the CPU 109 controls the operation timing of the imaging element 105, the image signal processing unit 107, and the frame memory 108. The nonvolatile memory 111 is constituted by an EEPROM (Electrically Erasable Programmable Read-Only Memory) or the like, and does not lose the recorded data even if the power source 110 is turned OFF. The initial camera setting values which are set to a camera when the power source 110 is turned ON are recorded in the nonvolatile memory 111.

The second PD selecting/composing unit 151 executes processing (selecting/composing processing) for selecting left-eye RAW data or right-eye RAW data from RAW data stored in the frame memory 108 or the RAM memory 113 and composing the selected RAW data based on the setting of a pixel selecting/composing parameter. The CPU 109 sets the pixel selecting/composing parameter in response to the type of photographing for which the start has been detected.

The pixel selecting/composing parameter is a parameter for determining which one of the RAW data corresponding to the images signals generated by PDs is composed and output, that is, a parameter for setting the operation mode of the second PD selecting/composing unit 151.

Examples of such a pixel selecting/composing parameter include a left-eye image composing parameter and a right-eye image composing parameter. The left-eye image composing parameter is a parameter for setting the operation mode of the second PD selecting/composing unit 151 to a left-eye selecting/composing mode. The left-eye selecting/composing mode is an operation mode for composing and outputting left-eye image data (executing left-eye image composing processing). The right-eye image composing parameter is a parameter for setting the operation mode of the second PD selecting/composing unit 151 to a right-eye selecting/composing mode. The right-eye selecting/composing mode is an operation mode for composing and outputting right-eye image data (executing right-eye image composing processing).

Left-eye image composing processing is the same as operation processing performed by the first PD selecting/composing unit 106 when the aforementioned operation mode is the live-view left-eye mode. More specifically, the second PD selecting/composing unit 151 generates left-eye still picture data based on RAW data for a still picture corresponding to a left-eye image signal among the RAW data for still picture stored in the frame memory 108. When the RAW data stored in the frame memory 108 is RAW data including left-eye RAW data and right-eye RAW data both for live-view, the second pixel selecting/composing unit 151 may also execute left-eye image composing processing as follows. The second pixel selecting/composing unit 151 acquires left-eye RAW data for live-view from the RAW data stored in the frame memory 108.

Right-eye image composing processing is the same as operation processing performed by the first PD selecting/composing unit 106 when the aforementioned operation mode is the live-view right-eye mode. More specifically, the second PD selecting/composing unit 151 generates right-eye still picture data based on RAW data for still picture corresponding to a right-eye image signal among the RAW data for still picture stored in the frame memory 108. When the RAW data stored in the frame memory 108 is RAW data including left-eye RAW data and right-eye RAW data both for live-view, the second pixel selecting/composing unit 151 may also execute right-eye image composing processing as follows. The second pixel selecting/composing unit 151 acquires right-eye RAW data for live-view from the RAW data stored in the frame memory 108.

The second PD selecting/composing unit 151 stores the right-eye/left-eye image data obtained by selecting/composing processing in the RAM memory 113. In other words, the second PD selecting/composing unit 151 functions as a controller that generates and outputs left-eye image data or right-eye image data based on the image data stored in the frame memory 108 in response to the type of photographing for which the start has been detected.

While, in the present embodiment, RAW data is input to the second PD selecting/composing unit 151 via the frame memory 108 or the RAM memory 113, RAW data may also be input directly from the image signal processing device 107 to the second PD selecting/composing unit 151.

The development processing unit 112 performs image processing for RAW data composed for each pixel portion, which is stored in the frame memory 108 or the RAM memory 113 read by the CPU 109, based on the development parameter settings. Image data subject to image processing is stored in the RAM memory 113.

The development parameter is a parameter regarding the image quality of digital image data. All of the parameters for the white balance, color interpolation, color correction, γ conversion, edge emphasis, and resolution of digital image data correspond to the development parameters. Hereinafter, development processing for adjusting (changing) the image quality of digital image data using one or more development parameters is referred to as “development processing”. While, in the present embodiment, RAW data is input to the development processing unit 112 via the frame memory 108 or the RAM memory 113, RAW data may also be input directly from the image signal processing device 107 to the development processing unit 112.

The RAM memory 113 temporarily stores not only image data obtained as a result of development processing but also data obtained when the CPU 109 performs various processing operations. The display control device 114 drives and controls a TFT 115 including a liquid crystal display element. The display control device 114 outputs an image (display image) arranged in the RAM memory 113 in a display image format to a display device. The RAM memory 113 in which a display image is arranged is referred to as “VRAM”. In the present embodiment, in order to perform stereoscopic display, the display device can provide a stereoscopic display. In order to perform stereoscopic display, the VRAM includes a right-eye VRAM and a left-eye VRAM. The display device arranges a right-eye image included in the right-eye VRAM and a left-eye image included in the left-eye VRAM so as to perform stereoscopic display. In other words, the display control device functions as a display controller and alternately displays a left-eye image and a right-eye image generated from a left-eye image signal and a right-eye image signal, respectively, to thereby perform stereoscopic display. Also, the display control device superimposes a left-eye image and a right-eye image generated from a left-eye image signal and a right-eye image signal, respectively, and displays the superimposed image to thereby perform stereoscopic display.

When a user turns the main switch 116 “ON”, the CPU 109 executes a predetermined program. When a user turns the main switch 116 “OFF”, the CPU 109 executes a predetermined program and puts a camera in a stand-by mode. The first release switch 117 is turned “ON” by the first stroke (half-pressed state) of a release button, and the second release switch 118 is turned “ON” by the second stroke (full-pressed state) of the release button. When the first release switch 117 is turned “ON”, the CPU 109 executes photography preparation processing (e.g., focal point detection processing or the like). When the second release switch 118 is turned “ON”, the CPU 109 detects the start of photographing (in this example, still picture photographing) and executes a photographing operation.

The CPU 109 performs control in accordance with the pressing of a left selection button 140, a right selection button 141, or a setting button 142 and the operation state of a digital camera. For example, when the operation state of the digital camera is a reproduction state and the left selection button 140 is pressed, the CPU 109 displays the previous image data. When the right selection button 141 is pressed, the CPU 109 displays the next image data.

The development parameters are parameters regarding development, which are set in accordance with a menu operation by a user using the development parameter change button 143. A user can confirm and set the development parameters on a graphical user interface.

When a user presses the live-view start/end button 144, the CPU 109 captures RAW data from the imaging element 105 at regular intervals (e.g., 30 times for 1 sec). Then, the development processing unit 112 performs development processing for RAW data and arranges the resulting RAW data in a VRAM in accordance with the instructions given by the CPU 109, whereby an image captured from the imaging element 105 can be displayed in real-time. When a user presses the live-view start/end button 144 in a state where the live-view is active, the CPU 109 ends the live-view state.

A LAN control device 129 controls communication between an imaging apparatus and an external device via a wired LAN terminal 130 or a wireless LAN 131. The USB control device 127 controls communication between an imaging apparatus and an external device via a USB terminal 128.

### First Embodiment

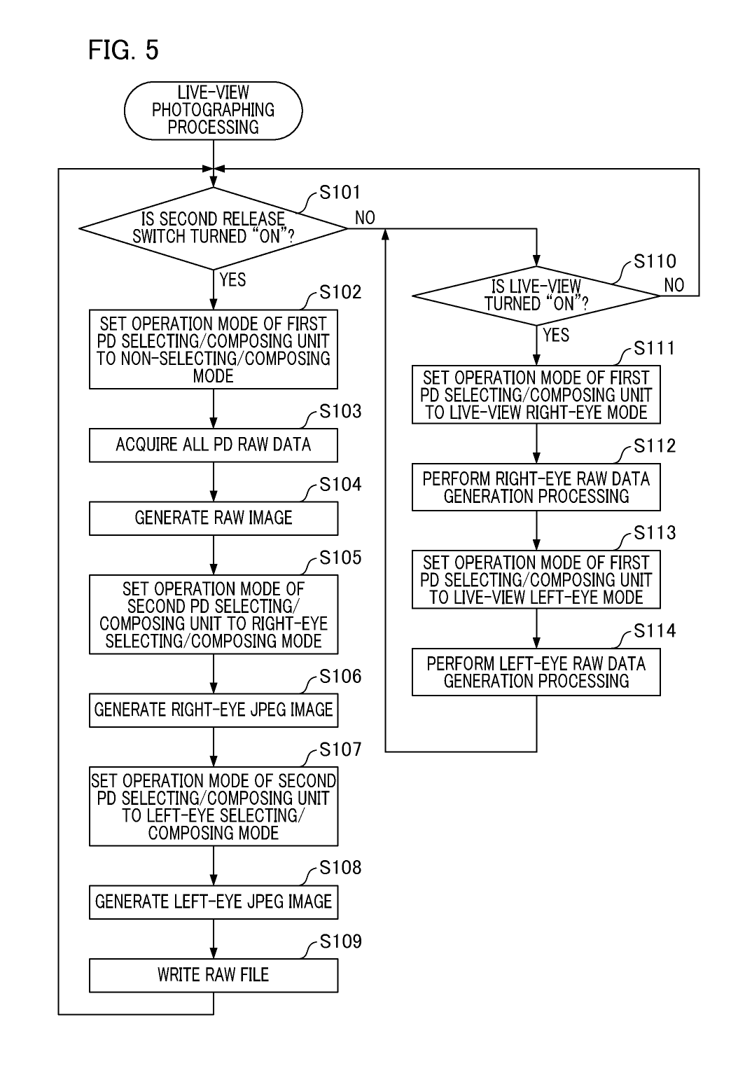

FIG. 5 is a flowchart illustrating an example of operation processing performed by the imaging apparatus of the first embodiment. Firstly, the CPU 109 determines whether or not the second release switch is turned “ON” (step S101). When the second release switch is turned “ON”, the CPU 109 determines that still picture photographing has been started. Then, the process advances to step S102. When the second release switch is not turned “ON”, the process advances to step S110.

In step S102, the CPU 109 sets the operation mode of the first PD selecting/composing unit 106 to the non-selecting/composing mode (step S102). Next, when the CPU 109 starts photographing, the first PD selecting/composing unit 106 stores all PD RAW data in the frame memory 108 (step S103).

Next, the development processing unit 112 reads all PD RAW data from the frame memory 108, develops all the read PD RAW data using development parameters for RAW image, and arranges the development result, i.e., RAW image data in the RAM memory 113 (step S104).

Next, the CPU 109 sets the operation mode of the second PD selecting/composing unit 151 to the right-eye selecting/composing mode (step S105). Next, the CPU 109 inputs all PD RAW data in the frame memory 108 to the second PD selecting/composing unit 151. Then, the second PD selecting/composing unit 151 generates right-eye RAW data using all the input PD RAW data, and stores the generated right-eye RAW data in the RAM memory 113. Furthermore, the second PD selecting/composing unit 151 performs development processing for right-eye RAW data in the RAM memory 113 by means of the development processing unit 112 using development parameters for JPEG image, and arranges the development result, i.e., a right-eye JPEG image in the RAM memory 113 (step S106).

Next, the CPU 109 sets the operation mode of the second PD selecting/composing unit 151 to the left-eye selecting/composing mode (step S107). Next, the CPU 109 inputs all PD RAW data in the frame memory 108 to the second PD selecting/composing unit 151. Then, the second PD selecting/composing unit 151 generates left-eye RAW data using all the input PD RAW data, and stores the generated left-eye RAW data in the RAM memory 113.

Furthermore, the second PD selecting/composing unit 151 performs development processing for left-eye RAW data in the RAM memory 113 by means of the development processing unit 112 using development parameters for a JPEG image, and arranges the development result, i.e., a left-eye JPEG image in the RAM memory 113 (step S108).

Next, the CPU 109 stores the RAW image data generated in step S104, the right-eye JPEG image generated in step S106, and the left-eye JPEG image generated in step S108 as one Exif standard file (step S109). More specifically, the CPU 109 stores the RAW image data, the right-eye JPEG image, and the left-eye JPEG image in the memory card 121 via the card input/output unit 119. In other words, the CPU 109 functions as a recording controller that controls to record the right-eye JPEG image, the left-eye JPEG image, and an image signal in which the right-eye JPEG image and the left-eye JPEG image are composed in the memory card 121.

In step S110, the CPU 109 determines whether or not the live-view start/end button 144 is turned “ON” in a state where the live-view is not started (step S110). When the live-view start/end button 144 is not turned “ON”, the process returns to step S101. When the live-view start/end button 144 is turned “ON”, the CPU 109 detects that live-view photographing has been started. Then, the process advances to step S111.

In step S111, the CPU 109 sets the operation mode of the first PD selecting/composing unit 106 to the live-view right-eye mode (step S111). Next, the CPU 109 starts photographing using photographing parameters for live-view. The first PD selecting/composing unit 106 generates right-eye RAW data, and stores the generated right-eye RAW data in the frame memory 108 (step S112). The development processing unit 112 develops right-eye RAW data in the frame memory 108 using the development parameters for display, and arranges the developed image in a right-eye VRAM. Then, the process advances to step S113.

In step S113, the CPU 109 sets the operation mode of the first PD selecting/composing unit 106 to the live-view left-eye mode (step S113). Next, the CPU 109 starts photographing using photographing parameters for live-view. The first PD selecting/composing unit 106 generates left-eye RAW data, and stores the generated left-eye RAW data in the frame memory 108 (step S114). The development processing unit 112 develops left-eye RAW data in the frame memory 108 using the development parameters for display, and arranges the developed image in a left-eye VRAM. Then, the process returns to step S110.

According to the imaging apparatus of the first embodiment, when a live-view stereoscopic image is displayed, a right-eye image and a left-eye image are simultaneously generated by the first PD selecting/composing unit 106 provided in the imaging element 105, and thus, the amount of the output data of the imaging element can be suppressed to a low level, resulting in realizing a high frame rate. Since the amount of the output data of the imaging element is suppressed to a low level, the time taken to capture an image signal from the imaging element can be reduced. In addition, according to the imaging apparatus of the first embodiment, the first PD selecting/composing unit 106 in the imaging element 105 outputs all of information about the PDs provided in the imaging element during still picture photographing, and thus, the degree of freedom for image processing in later steps can be increased.

### Second Embodiment

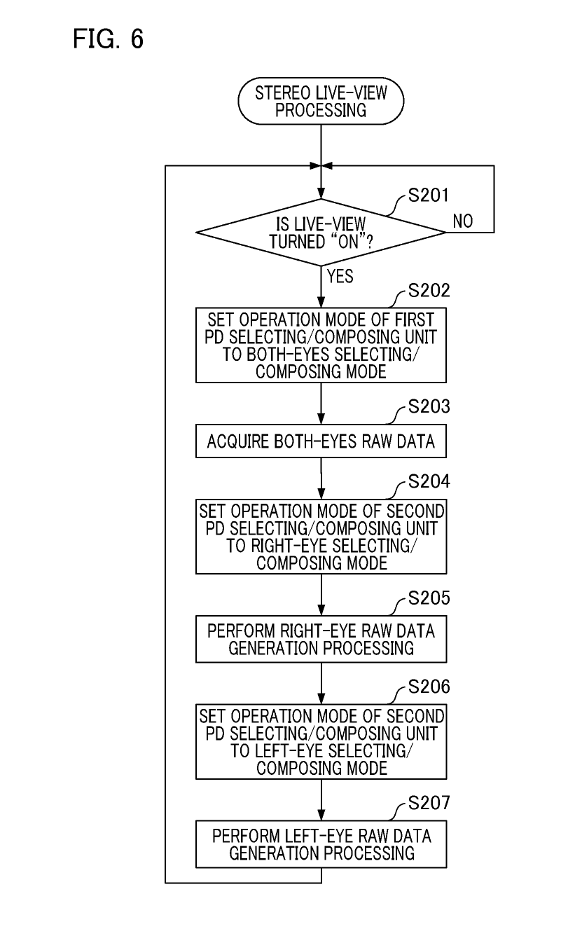

FIG. 6 is a flowchart illustrating an example of operation processing performed by the imaging apparatus of the second embodiment. Processing to be described with reference to the flowchart shown in FIG. 6 is processing performed when the start of live-view photographing is detected. Processing performed when the start of still picture photographing is detected is the same as that in the first embodiment.

Firstly, the CPU 109 determines whether or not the live-view start/end button 144 is turned “ON” in a state where the live-view has not started (step S201). When the live-view start/end button 144 is not turned “ON”, the process returns to step S201. When the live-view start/end button 144 is turned “ON”, the CPU 109 detects that live-view photographing has been started. Then, the process advances to step S202.

In step S202, the CPU 109 sets the operation mode of the first PD selecting/composing unit 106 to the both-eyes selecting/composing mode (step S202). The CPU 109 starts photographing using photographing parameters for live-view. Then, the first PD selecting/composing unit 106 for which the operation mode is set to the both-eyes selecting/composing mode averages the image signals generated by the selected PDs provided in the pixel portions which are treated as one processing unit for the PDs for generating a left-eye image signal and the PDs for generating a right-eye image signal, respectively. The first PD selecting/composing unit 106 outputs the addition/averaging result as two image signals corresponding to one pixel portion. The first PD selecting/composing unit 106 executes signal output processing for all of the processing units. In this manner, the first PD selecting/composing unit 106 generates RAW data (both-eyes RAW data) including left-eye RAW data and right-eye RAW data for live-view. The first PD selecting/composing unit 106 stores the generated both-eyes RAW data in the frame memory 108 (step S203).

A description will be given below of specific processing in step S203. The first PD selecting/composing unit 106 selects a predetermined plurality of pixel portions from a plurality of pixel portions as one processing unit and averages the right-eye image signals generated by the PDs 402a, 402d, and 402g provided in the pixel portions which are treated as the processing unit. Also, the first PD selecting/composing unit 106 selects a predetermined plurality of pixel portions from a plurality of pixel portions as one processing unit and averages the left-eye image signals generated by the PDs 402c, 402f, and 402i provided in the pixel portions which are treated as the processing unit. The first PD selecting/composing unit 106 sets these two addition/averaging results as both-eyes RAW data.

Next, the CPU 109 sets the operation mode of the second PD selecting/composing unit 106 to the right-eye selecting/composing mode (step S204). Next, the CPU 109 inputs both-eyes RAW data in the frame memory 108 to the second PD selecting/composing unit 106. Then, the second PD selecting/composing unit 151 generates right-eye RAW data using the input both-eyes RAW data, and stores the generated right-eye RAW data in the RAM memory 113 (step S205). Furthermore, the development processing unit 112 develops right-eye RAW data in the frame memory 108 using the development parameters for display, and arranges the developed image in the right-eye VRAM. Then, the process advances to step S206.

Next, the CPU 109 sets the operation mode of the second PD selecting/composing unit 106 to the left-eye selecting/composing mode (step S206). Next, the CPU 109 inputs both-eyes RAW data in the frame memory 108 to the second PD selecting/composing unit 106. Then, the second PD selecting/composing unit 151 generates left-eye RAW data using the input both-eyes RAW data, and stores the generated left-eye RAW data in the RAM memory 113 (step S207). Furthermore, the development processing unit 112 develops left-eye RAW data in the frame memory 108 using the development parameters for display, and arranges the developed image in the left-eye VRAM. Then, the process returns to step S200.

According to the imaging apparatus of the second embodiment, when a live-view stereoscopic image is displayed, a right-eye image and a left-eye image are simultaneously generated by the first PD selecting/composing unit 106 provided in the imaging element 105, and thus, the amount of the output data of the imaging element can be suppressed to a low level, resulting in realizing a high frame rate. Also, the imaging apparatus of the second embodiment acquires a right-eye image and a left-eye image simultaneously from the imaging element 105. Thus, according to the imaging apparatus of the second embodiment, an image with no time difference between the right-eye image and the left-eye image can be displayed stereoscopically.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-207431 filed Sep. 22, 2011, which is hereby incorporated by reference herein in its entirety.

What is claimed is:

1. An imaging apparatus comprising:
an imaging element in which pixel portions each having a plurality of four or more photoelectric conversion units, which generate image signals by photoelectrical conversion, with respect to one micro lens are arranged side by side in a horizontal direction and a vertical direction;
an imaging element controller having a first mode which outputs a first left-eye image signal and/or right-eye image signal from the imaging element by composing signals from the plurality of photoelectric conversion units and a second mode which outputs signals without the composing; and
a controller that outputs a second left-eye image signal and/or right-eye image signal by composing signals output in the second mode based on image data stored in a storage unit in response to the type for photographing of which the start has been detected.

2. The imaging apparatus according to claim 1, wherein the second mode is selected when still picture recording is performed.

3. The imaging apparatus according to claim 1, wherein the first mode is selected when the imaging apparatus is in a live-view mode.

4. The imaging apparatus according to claim 1, further comprising:
a display controller that controls to alternately display a left-eye image and a right-eye image generated from the first left-eye image signal and right-eye image signal, respectively.

5. The imaging apparatus according to claim 1, further comprising:
a display controller that controls to superimpose a left-eye image and a right-eye image generated from the first left-eye image signal and right-eye image signal, respectively.

6. The imaging apparatus according to claim 1, further comprising:
a recording controller that controls to record a left-eye image signal and a right-eye image signal generated from the second left-eye image signal and right-eye image signal, respectively, and a signal in which the left-eye image signal and the right-eye image signal are composed when the imaging apparatus is in the second mode.

7. The imaging apparatus according to claim 1, wherein, when the type of photographing for which the start has been detected is a live-view photographing, the imaging element controller selects a predetermined plurality of pixel portions from the plurality of pixel portions as one processing unit, selects a predetermined plurality of photoelectric conversion units as a first photoelectric conversion unit from the photoelectric conversion units provided in the selected pixel portions, and executes signal output processing for outputting an image signal corresponding to one pixel portion by averaging image signals generated by the selected first photoelectric conversion unit for all of the processing units to thereby generate motion picture data corresponding to the first left-eye image signal or right-eye image signal, and then, the imaging element controller selects the unselected photoelectric conversion unit as a second photoelectric conversion unit and executes the signal output processing for all of the processing units to thereby generate moving picture data corresponding to the first left-eye image signal or right-eye image signal generated by the second photoelectric conversion unit.

8. The imaging apparatus according to claim 1, wherein, when the type of photographing for which the start has been detected is the live-view photographing, the imaging element controller selects a predetermined plurality of pixel portions from the plurality of pixel portions as one processing unit, selects a predetermined plurality of photoelectric conversion units as a first photoelectric conversion unit and a second photoelectric conversion unit from the photoelectric conversion units provided in the selected pixel portions, and executes signal output processing for outputting two image signals corresponding to one pixel portion by averaging image signals, which has been generated by the selected photoelectric conversion units provided in the selected pixel portions as the processing unit, for each of the first and the second photoelectric conversion units, respectively, for all of the processing units to thereby generate moving picture data including the first left-eye image signal and right-eye image signal and store the moving picture data in the storage unit.

9. The imaging apparatus according to claim 7, wherein each of the pixel portions provided in the imaging element has a color filter and the pixel portions are arranged in a predetermined pixel array, and
wherein the imaging element controller selects a predetermined number of pixel portions having the same color filter in the horizontal direction from among the plurality of pixel portions provided in the imaging element, and sets the selected number of pixel portions as the processing unit.

10. The imaging apparatus according to claim 7, wherein each of the pixel portions provided in the imaging element has a color filter and the pixel portions are arranged in a predetermined pixel array, and
wherein the imaging element controller selects a predetermined number of pixel portion groups at predetermined intervals in the vertical direction, selects a predetermined number of pixel portions having the same color filter in the horizontal direction from among the pixel portions included in each of the selected pixel portion groups, and sets the selected number of pixel portions as the processing unit.

11. An imaging apparatus comprising:
an imaging element in which pixel portions each having a plurality of photoelectric conversion units, which photoelectrically convert light fluxes having passed through different divided regions of an exit pupil of an imaging optical system to thereby generate image signals, with respect to one micro lens are arranged side by side in a horizontal direction and a vertical direction;
an imaging element controller having a first mode which outputs a first left-eye image signal and/or right-eye image signal from the imaging element by composing signals from the plurality of photoelectric conversion units and a second mode which outputs signals without the composing; and
a controller that outputs a second left-eye image signal and/or right-eye image signal by composing signals output in the second mode based on image data stored in a storage unit in response to the type of photographing for which the start has been detected.

12. A method for controlling an imaging apparatus comprising an imaging element in which pixel portions each having a plurality of four or more photoelectric conversion units, which generate image signals by photoelectrical conversion, with respect to one micro lens are arranged side by side in a horizontal direction and a vertical direction, the method comprising:
outputting a first left-eye image signal and/or right-eye image signal from the imaging element by composing signals from the plurality of photoelectric conversion units in a first mode and outputting signals without the composing in a second mode; and
outputting a second left-eye image signal and/or right-eye image signal by composing signals output in the second mode based on image data stored in a storage unit in response to the type of photographing for which the start has been detected.
